(19) United States
(12) Patent Application Publication
(10) Pub. No.: US 2008/0137203 A1
(43) Pub. Date: Jun. 12, 2008

(54) Optical plate having three layers and backlight module with same

(75) Inventors: Tung-Ming Hsu, Tu-cheng (TW); Shao-Han Chang, Tu-cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI Precision Industry Co., LTD, Tu-Cheng City (TW)

(21) Appl. No.: 11/786,991

(22) Filed: Apr. 13, 2007

(30) Foreign Application Priority Data
Dec. 8, 2006 (CN) 200610201253.0

(51) Int. Cl. G02B 5/02

(52) U.S. Cl. 359/599

(57) ABSTRACT

An exemplary optical plate includes a first transparent layer, a second transparent layer and a light diffusion layer. The light diffusion layer is between the first and second transparent layers. The light diffusion layer, the first transparent layer, and the second transparent layer are integrally formed. The light diffusion layer includes a transparent matrix resin, and diffusion particles dispersed in the transparent matrix resin. The first transparent layer defines first spherical depressions at an outer surface thereof that is farthest from the second transparent layer. The second transparent layer defines second spherical depressions at an outer surface thereof that is farthest from the first transparent layer. A backlight module using the optical plate is also provided.

### CROSS-REFERENCE TO RELATED APPLICATIONS

This application is related to fourteen copending U.S. patent applications, which are: application Ser. No. 11/620,951 filed on Jan. 8, 2007, and entitled “OPTICAL PLATE HAVING THREE LAYERS”; application Ser. No. 11/620,958, filed on Jan. 8, 2007, and entitled “OPTICAL PLATE HAVING THREE LAYERS AND MICRO PROTRUSIONS”; application Ser. No. 11/623,302, filed on Jan. 5, 2007, and entitled “OPTICAL PLATE HAVING THREE LAYERS”; application Ser. No. 11/623,303, filed on Jan. 15, 2007, and entitled “OPTICAL PLATE HAVING THREE LAYERS AND BACKLIGHT MODULE WITH SAME”; application Ser. No. 11/627,579, filed on Jan. 26, 2007, and entitled “OPTICAL PLATE HAVING THREE LAYERS”; application Ser. No. 11/672,359, filed on Feb. 7, 2007, and entitled “OPTICAL PLATE HAVING THREE LAYERS AND BACKLIGHT MODULE WITH SAME”; application Ser. No. 11/716,323, filed on Mar. 9, 2007, and entitled “OPTICAL PLATE HAVING THREE LAYERS AND BACKLIGHT MODULE WITH SAME”; application Ser. No. 11/716,140, filed on Mar. 9, 2007, and entitled “THREE-LAYERED OPTICAL PLATE AND BACKLIGHT MODULE WITH SAME”; application Ser. No. 11/716,158, filed on Mar. 9, 2007, and entitled “OPTICAL PLATE HAVING THREE LAYERS AND BACKLIGHT MODULE WITH SAME”; application Ser. No. 11/716,143, filed on Mar. 9, 2007, and entitled “OPTICAL PLATE HAVING THREE LAYERS AND BACKLIGHT MODULE WITH SAME”; and application Ser. No. 11/716,141, filed on Mar. 9, 2007, and entitled “OPTICAL PLATE HAVING THREE LAYERS AND BACKLIGHT MODULE WITH SAME”; application serial no. [to be advised], Attorney Docket No. US12890, and entitled “OPTICAL PLATE HAVING THREE LAYERS AND BACKLIGHT MODULE WITH SAME”; application serial no. [to be advised], Attorney Docket No. US12897, and entitled “OPTICAL PLATE HAVING THREE LAYERS AND BACKLIGHT MODULE WITH SAME”; and application serial no. [to be advised], Attorney Docket No. US12898, and entitled “OPTICAL PLATE HAVING THREE LAYERS AND BACKLIGHT MODULE WITH SAME”. In all these copending applications, the inventor is Tung-Ming Hsu et al. All of the copending applications have the same assignee as the present application. The disclosures of the above identified applications are incorporated herein by reference.

### BACKGROUND OF THE INVENTION

1. Field of the Invention

The present invention relates to an optical plate for use in, for example, a backlight module, the backlight module typically being employed in a liquid crystal display (LCD).

2. Discussion of the Related Art

The lightness and slimness of LCD panels make them suitable for use in a wide variety of electronic devices such as personal digital assistants (PDAs), mobile phones, portable personal computers, and other electronic appliances. Liquid crystal is a substance that does not itself emit light. Rather, the liquid crystal relies on light from a light source in order to display data and images. In a typical LCD panel, a backlight module powered by electricity supplies the needed light.

FIG. 7 is an exploded, side cross-sectional view of a typical direct type backlight module 10 employing a typical optical diffusion plate. The backlight module 10 includes a housing 11, a plurality of lamps 12 disposed above a base of the housing 11 for emitting light rays, and a light diffusion plate 13 and a prism sheet 15 stacked on top of the housing 11 in that order. Inside walls of the housing 11 are configured for reflecting certain of the light rays upward. The light diffusion plate 13 includes a plurality of dispersion particles therein. The dispersion particles are configured for scattering the light rays, and thereby enhancing the uniformity of light output from the light diffusion plate 13. This can correct what might otherwise be a narrow viewing angle experienced by a user of a corresponding LCD panel (not shown). The prism sheet 15 includes a plurality of V-shaped structures at a top thereof.

In use, light rays from the lamps 12 enter the prism sheet 15 after being scattered in the light diffusion plate 13. The light rays are refracted and concentrated by the V-shaped structures of the prism sheet 15 so as to increase brightness of light illumination, and finally propagate into the LCD panel (not shown) disposed above the prism sheet 15. The brightness can be improved by the V-shaped structures, but the viewing angle may be narrowed. In addition, even though the light diffusion plate 13 and the prism sheet 15 abut each other, a plurality of air pockets still exist at the boundary between them. When the backlight module 10 is in use, light passes through the air pockets, and some of the light undergoes total reflection at the air pockets. As a result, the light energy utilization ratio of the backlight module 10 is reduced.

Therefore, a new optical means is desired in order to overcome the above-described shortcomings. A backlight module utilizing such optical means is also desired.

### SUMMARY

In one aspect, an optical plate includes a first transparent layer, a second transparent layer and a light diffusion layer. The light diffusion layer is between the first and second transparent layers. The light diffusion layer, the first transparent layer and the second transparent layer are integrally formed. The light diffusion layer includes a transparent matrix resin, and a plurality of diffusion particles dispersed in the transparent matrix resin. The first transparent layer includes a plurality of first spherical depressions at an outer surface thereof that is farthest from the second transparent layer. The second transparent layer includes a plurality of second spherical depressions at an outer surface thereof that is farthest from the first transparent layer.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and backlight module. Moreover, in the drawings, like reference numerals designate corresponding parts throughout the several views, and all the views are schematic.

FIG. 1 is an isometric view of an optical plate in accordance with a first embodiment of the present invention.

FIG. 2 is a side cross-sectional view of the optical plate of FIG. 1, taken along line II-II thereof.

FIG. 3 is a bottom plan view of the optical plate of FIG. 1.

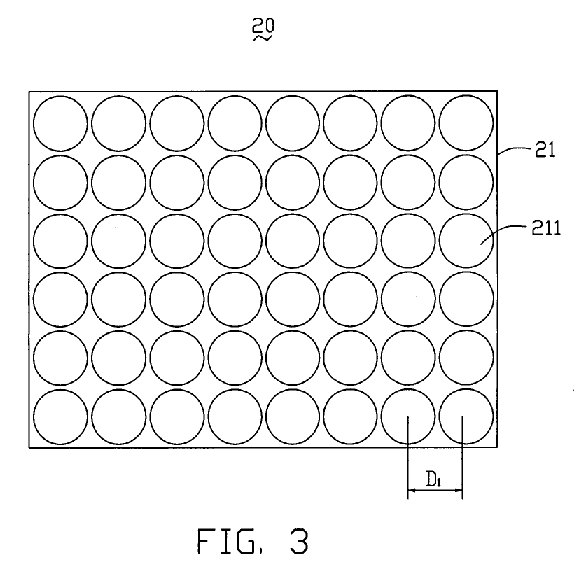

FIG. 4 is an exploded, side cross-sectional view of a direct type backlight module in accordance with a second embodiment of the present invention, the backlight module including the optical plate shown in FIG. 2.

FIG. 5 is a bottom plan view of an optical plate in accordance with a third embodiment of the present invention.

FIG. 6 is a side cross-sectional view of an optical plate in accordance with a fourth embodiment of the present invention.

FIG. 7 is an exploded, side cross-sectional view of a conventional backlight module having a light diffusion plate and a prism sheet.

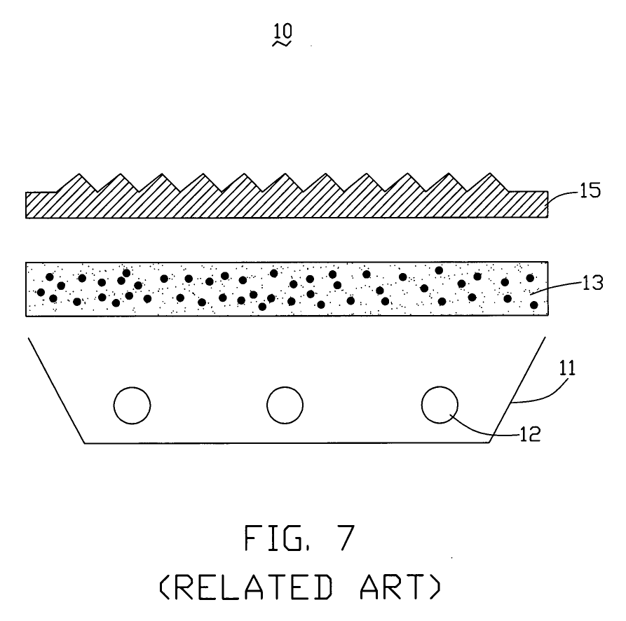

### DETAILED DESCRIPTION OF THE EMBODIMENTS

Reference will now be made to the drawings to describe preferred embodiments of the present optical plate and backlight module, in detail.

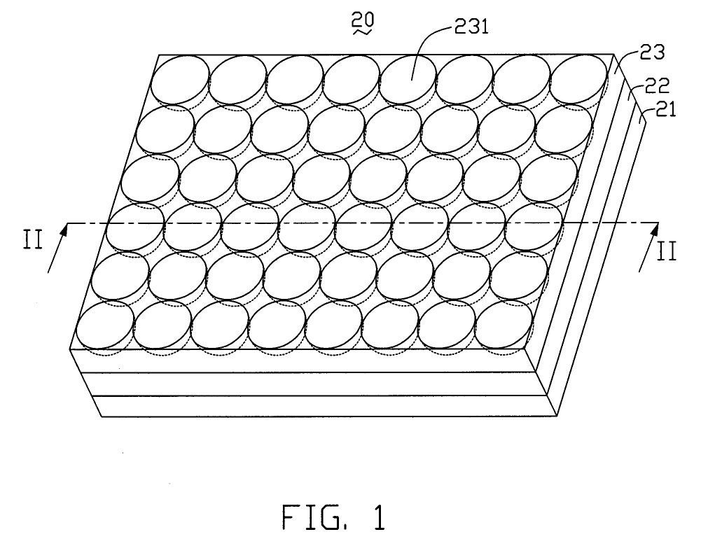

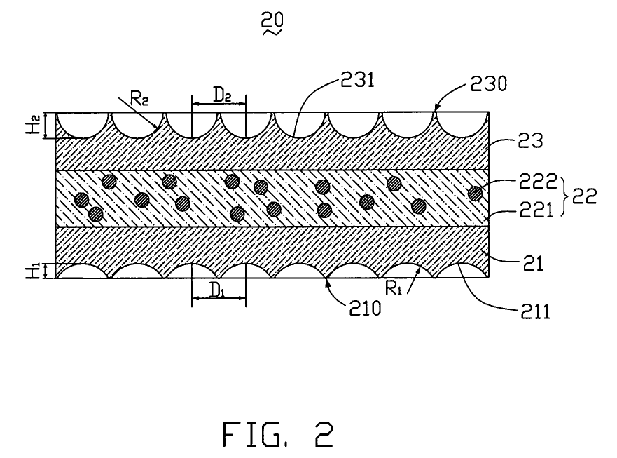

Referring to FIGS. 1 and 2, an optical plate 20 according to a first embodiment of the present invention is shown. The optical plate 20 includes a first transparent layer 21, a light diffusion layer 22, and a second transparent layer 23. The light diffusion layer 22 is between the first transparent layer 21 and the second transparent layer 23. The first transparent layer 21, the light diffusion layer 22, and the second transparent layer 23 are integrally formed as a single body by multi-shot injection molding technology. That is, the first transparent layer 21 and the light diffusion layer 22 are in immediate contact with each other at a first common interface therebetween, and the second transparent layer 23 and the light diffusion layer 22 are in immediate contact with each other at a second common interface therebetween. The first transparent layer 21 includes a plurality of first spherical depressions 211 at an outer surface 210 thereof that is farthest from the second transparent layer 23. The second transparent layer 23 includes a plurality of second spherical depressions 231 at an outer surface 230 thereof that is farthest from the first transparent layer 21.

In the illustrated embodiment, each first spherical depression 211 has a sub-hemispherical shape. Thus a maximum depth H₁ of the first spherical depression 211 is less than a radius R₁ of the first spherical depression 211. The first spherical depressions 211 are arranged separately from one another at the outer surface 210 in a matrix. In order to achieve high quality optical effects, the radius R₁ of each first spherical depression 211 is preferably in a range from about 0.01 millimeters to about 3 millimeters. The maximum depth H₁ of each first spherical depression 211 is preferably at least 0.01 millimeters. In other embodiments, the maximum depth H₁ can be as much as R₁. That is, 0.01 mm≦H₁≦R₁. Thus, the maximum depth H₁ is preferably in a range from about 0.01 millimeters to about 3 millimeters. A pitch D₁ between adjacent first spherical depressions 211 is preferably in the following range: R₁/2≦D₁≦4R₁. That is, the pitch D₁ is preferably in the range from about 0.005 millimeters to about 12 millimeters.

The second spherical depressions 231 are configured for collimating emitting light to a certain extent, and thus improving a brightness of light illumination. In the illustrated embodiment, each second spherical depression 231 is a hemispherical depression. The second spherical depressions 231 are arranged separately from one another at the outer surface 230 in a matrix. In order to achieve high quality optical effects, a radius R₂ of each second spherical depression 231 is preferably in a range from about 0.01 millimeters to about 3 millimeters. A maximum depth H₂ of each second spherical depression 231 is preferably in the following range: 0.01 millimeters≦H₂≦R₂. That is, the maximum depth H₂ is preferably in a range from about 0.01 millimeters to about 3 millimeters. A pitch D₂ between two adjacent second spherical depressions 231 is preferably in the following range: R₂/2≦D₂≦4R₂. That is, the pitch D₂ is preferably in a range from about 0.005 millimeters to about 12 millimeters. In the illustrated embodiment, the maximum depth H₂ is equal to R₂, and the pitch D₂ is greater than 2R₂. In alternative embodiments, the second spherical depressions 231 can be substantially the same as the first spherical depressions 211. Further, in the illustrated embodiment, the first spherical depressions 211 are arranged in one-to-one correspondence with the second spherical depressions 231.

A thickness of each of the first transparent layer 21, the light diffusion layer 22, and the second transparent layer 23 can be equal to or greater than 0.35 millimeters. In a preferred embodiment, a combined thickness of the first transparent layer 21, the light diffusion layer 22, and the second transparent layer 23 is preferably in the range from about 1.05 millimeters to about 6 millimeters. Each of the first transparent layer 21 and the second transparent layer 23 is preferably made of one or more transparent matrix resins selected from the group including polyacrylic acid (PAA), polycarbonate (PC), polystyrene (PS), polymethyl methacrylate (PMMA), methylmethacrylate and styrene copolymer (MS), and any suitable combination thereof. It should be pointed out that the materials of the first transparent layer 21 and the second transparent layer 23 can be the same or can be different.

The light diffusion layer 22 includes a transparent matrix resin 221, and a plurality of diffusion particles 222 dispersed in the transparent matrix resin 221. In a typical embodiment, the diffusion particles 222 are substantially uniformly dispersed in the transparent matrix resin 221. The light diffusion layer 22 is configured for enhancing uniformity of light output from the optical plate 20. The transparent matrix resin 221 is selected from the group consisting of polyacrylic acid (PAA), polycarbonate (PC), polystyrene (PS), polymethyl methacrylate (PMMA), methylmethacrylate and styrene copolymer (MS), and any suitable combination thereof. The diffusion particles 222 can be made of material selected from the group consisting of titanium dioxide, silicon dioxide, acrylic resin, and any combination thereof. The diffusion particles 222 are configured for scattering light and enhancing a light distribution capability of the light diffusion layer 22. The light diffusion layer 22 preferably has a light transmission ratio in a range from 30% to 98%. The light transmission ratio of the light diffusion layer 22 is determined by a composition of the transparent matrix resin 221 and the diffusion particles 222.

In alternative embodiments, the first and second spherical depressions 211, 231 are not limited to being arranged in a regular matrix. Either or both of the first and second spherical depressions 211, 231 can instead be arranged otherwise. For example, the spherical depressions 231 can be arranged in rows, with the spherical depressions 231 in each row being offset from (staggered relative to) the spherical depressions 231 in each of the adjacent rows. In another example, the spherical depressions 211, 231 may be arranged randomly at the respective outer surface(s). Furthermore, the spherical depressions 211, 231 may be of different sizes and/or of different shapes. For example, a radius of each spherical depression 211, 231 in a predetermined group of spherical depressions 211, 231 may be different (larger or smaller) than a radius of each spherical depression 211, 231 in another predetermined group of spherical depressions 211, 231.

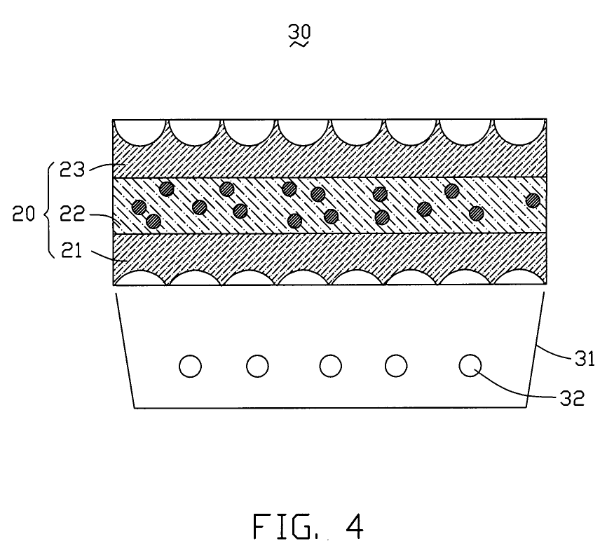

Referring to FIG. 4, a direct type backlight module 30 according to a second embodiment of the present invention is shown. The backlight module 30 includes a housing 31, a plurality of lamp tubes 32, and the optical plate 20. The lamp tubes 32 are arranged regularly above a base of the housing 31. The optical plate 20 is positioned at a top of the housing 31, with the first transparent layer 21 facing the lamp tubes 32. In an alternative embodiment, the second transparent layer 23 of the optical plate 20 can be arranged to face the lamp tubes 32. That is, the optical plate 20 can be selectively configured in the backlight module 30 to have light from the lamp tubes 32 entering either the first transparent layer 21 or the second transparent layer 23.

In the backlight module 30, when the light from the lamp tubes 32 enters the optical plate 20 via the first transparent layer 21, the light is diffused by the first spherical depressions 211 of the first transparent layer 21. Then the light is further substantially diffused in the light diffusion layer 22. Finally, the light is condensed by the second spherical depressions 231 of the second transparent layer 23 before exiting the optical plate 20. Therefore, a brightness of the backlight module 30 is increased. In addition, because the light is diffused at two levels, a uniformity of the light output from the optical plate 20 is enhanced. Furthermore, since the first transparent layer 21, the light diffusion layer 22, and the second transparent layer 23 are integrally formed together (see above), few or no air or gas pockets exist at the respective common interfaces therebetween. Thus there is little or no back reflection at the common interfaces, and the efficiency of utilization of light rays is increased. Moreover, the optical plate 20 utilized in the backlight module 30 in effect replaces the conventional combination of a diffusion plate and a prism sheet. Thereby, a process of assembly of the backlight module 30 is simplified, and the efficiency of assembly is improved. Still further, a volume occupied by the optical plate 20 is less than a total volume occupied by the conventional combination of a diffusion plate and a prism sheet. Thereby, a volume of the backlight module 30 is reduced.

In the alternative embodiment, when the light from the lamp tubes 32 enters the optical plate 20 via the second transparent layer 23, the uniformity of light output from the optical plate 20 is also enhanced, and the utilization efficiency of light rays is also increased. Nevertheless, light exiting the optical plate 20 via the first transparent layer 21 is different from light exiting the optical plate 20 via the second transparent layer 23. For example, when the backlight module 30 is configured such that the light from the lamp tubes 32 enters the optical plate 20 via the first transparent layer 21, a viewing angle of the backlight module 30 is somewhat larger than that of the backlight module 30 having the light enter the optical plate 20 via the second transparent layer 23.

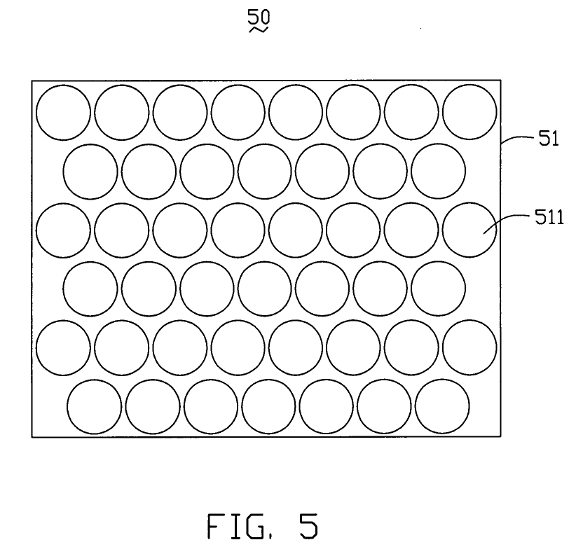

Referring to FIG. 5, an optical plate 50 according to a third embodiment of the present invention is shown. The optical plate 50 is similar in principle to the optical plate 20 of the first embodiment. However, the optical plate 50 includes a first transparent layer 51, and a plurality of spherical depressions 511 at an outer surface of the first transparent layer 51. The spherical depressions 511 are arranged in a series of rows. The spherical depressions 511 in each row are separate from and staggered relative to the spherical depressions 511 in each of the two adjacent rows. In an alternative embodiment, the spherical depressions 511 in each row can be staggered relative to and connected with the spherical depressions 511 in each of the two adjacent rows.

In the above-described embodiments, the first common interface between the light diffusion layer and the first transparent layer is substantially planar, and the second common interface between the light diffusion layer and the second transparent layer is also substantially planar. Alternatively, either or both of the common interfaces can be nonplanar. For example, either or both of the common interfaces can be curved or wavy.

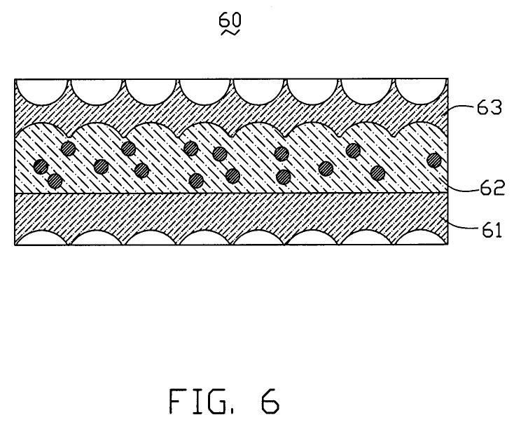

Referring to FIG. 6, an optical plate 60 according to a fourth embodiment of the present invention is shown. The optical plate 60 is similar in principle to the optical plate 20 of the first embodiment. However, the optical plate 60 includes a first transparent layer 61, a light diffusion layer 62, and a second transparent layer 63. A first common interface (not labeled) between the second transparent layer 63 and the light diffusion layer 62 is nonplanar. In the illustrated embodiment, the first common interface is defined by a plurality of spherical protrusions of the light diffusion layer 62 interlocked in a corresponding plurality of spherical depressions of the second transparent layer 63. Therefore, a binding strength between the second transparent layer 63 and the light diffusion layer 62 can be enhanced. In further or alternative embodiments, for example, a second common interface (not labeled) between the first transparent layer 61 and the light diffusion layer 62 can be nonplanar in the same way as the first common interface.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An optical plate, comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the light diffusion layer, the first transparent layer, and the second transparent layer are integrally formed, with the first transparent layer in immediate contact with the light diffusion layer, and the second transparent layer in immediate contact with the light diffusion layer, and the first transparent layer comprises a plurality of first spherical depressions at an outer surface thereof that is farthest from the second transparent layer, and the second transparent layer comprises a plurality of second spherical depressions at an outer surface thereof that is farthest from the first transparent layer.

2. The optical plate as claimed in claim 1, wherein a thickness of each of the light diffusion layer, the first transparent layer, and the second transparent layer is equal to or greater than 0.35 millimeters.

3. The optical plate as claimed in claim 2, wherein a combined thickness of the light diffusion layer, the first transparent layer and the second transparent layer is in the range from about 1.05 millimeters to about 6 millimeters.

4. The optical plate as claimed in claim 1, wherein each of the first transparent layer and the second transparent layer is made of material selected from the group consisting of polyacrylic acid, polycarbonate, polystyrene, polymethyl methacrylate, methylmethacrylate and styrene copolymer, and any combination thereof.

5. The optical plate as claimed in claim 1, wherein a depth of each of the first spherical depressions is in the range from about 0.01 millimeters to about 3 millimeters.

6. The optical plate as claimed in claim 1, wherein a pitch between two adjacent first spherical depressions is in the range from about 0.005 millimeters to about 12 millimeters.

7. The optical plate as claimed in claim 1, wherein a depth of each of the second spherical depressions is in the range from about 0.01 millimeters to about 3 millimeters.

8. The optical plate as claimed in claim 1, wherein, a pitch between two adjacent second spherical depressions is in the range from about 0.005 millimeters to about 12 millimeters.

9. The optical plate as claimed in claim 1, wherein at least one of the following arrangements is provided: the first spherical depressions are arranged in a series of rows at the outer surface of the first transparent layer, and the second spherical depressions are arranged in a series of rows at the outer surface of the second transparent layer.

10. The optical plate as claimed in claim 9, wherein at least one of the following arrangements is provided: the first spherical depressions in each row are staggered relative to the first spherical depressions in each of the two adjacent rows, and the second spherical depressions in each row are staggered relative to the second spherical depressions in each of the two adjacent rows.

11. The optical plate as claimed in claim 10, wherein at least one of the following arrangements is provided: the first spherical depressions in each row are staggered relative to and are separate from the first spherical depressions in each of the two adjacent rows, and the second spherical depressions in each row are staggered relative to and are separate from the second spherical depressions in each of the two adjacent rows.

12. The optical plate as claimed in claim 9, wherein the first spherical depressions are arranged in one-to-one correspondence with the second spherical depressions.

13. The optical plate as claimed in claim 1, wherein at least one of the following interfaces is planar: an interface between the light diffusion layer and the first transparent layer, and an interface between the light diffusion layer and the second transparent layer.

14. The optical plate as claimed in claim 1, wherein at least one of the following interfaces is nonplanar: an interface between the light diffusion layer and the first transparent layer, and an interface between the light diffusion layer and the second transparent layer.

15. The optical plate as claimed in claim 14, wherein the interface between the light diffusion layer and the second transparent layer is defined by a plurality of spherical protrusions of one of the light diffusion layer and the second transparent layer interlocked in a corresponding plurality of spherical depressions of the other of the light diffusion layer and the second transparent layer.

16. The optical plate as claimed in claim 1, wherein the transparent matrix resin is selected from the group consisting of polyacrylic acid, polycarbonate, polystyrene, polymethyl methacrylate, methylmethacrylate and styrene copolymer, and any combination thereof.

17. The optical plate as claimed in claim 1, wherein a material of the diffusion particles is selected from the group consisting of titanium dioxide, silicon dioxide, acrylic resin, and any combination thereof.

18. A direct type backlight module, comprising:
a housing;
a plurality of light sources disposed on or above a base of the housing; and
an optical plate disposed above the light sources at a top of the housing, the optical plate comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the first transparent layer, the light diffusion layer, and the second transparent layer are integrally formed, with the first transparent layer in immediate contact with the light diffusion layer, and the second transparent layer in immediate contact with the light diffusion layer, and the first transparent layer comprises a plurality of first spherical depressions at an outer surface thereof farthest from the second transparent layer, and the second transparent layer comprises a plurality of second spherical depressions at an outer surface thereof farthest from the first transparent layer.

19. The direct type backlight module as claimed in claim 18, wherein a selected one of the first transparent layer and the second transparent layer of the optical plate is arranged to face the light sources.

20. An optical plate, comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the light diffusion layer, the first transparent layer, and the second transparent layer are integrally formed as a single body, with the first transparent layer gaplessly in contact with the light diffusion layer, and the second transparent layer gaplessly in contact with the light diffusion layer, and the first transparent layer comprises a plurality of first spherical depressions at an outer surface thereof that is farthest from the second transparent layer, and the second transparent layer comprises a plurality of second spherical depressions at an outer surface thereof that is farthest from the first transparent layer.
